(19) United States
(12) Patent Application Publication
(10) Pub. No.: US 2007/0198334 A1
(43) Pub. Date: Aug. 23, 2007

(54) Spontaneous delivery marketing system and method

(76) Inventor: Robert Mebruer, Hong Kong (CN)

Correspondence Address: SUGHRUE MION, PLLC, 2100 PENNSYLVANIA AVENUE, N.W., SUITE 800, WASHINGTON, DC, 20037, US

(21) Appl. No.: 10/568,753

(22) PCT Filed: Aug. 18, 2004
(86) PCT No.: PCT/SG04/00249

§ 371 Date: Jul. 14, 2006

(30) Foreign Application Priority Data
Aug. 18, 2003 (AU) 2003904426

(51) Int. Cl. G06Q 30/00

(52) U.S. Cl. 705/14

(57) ABSTRACT

A spontaneous delivery marketing system and method is disclosed. Customised offers for consumers are generated by an application server (106) which extracts targeted offers for particular consumers from database (104) by application software contained in processor (P2) associated with the server (104) and server (106). Particular offers for particular consumers are transmitted to a first database (107). Consumers are identified without interaction by the consumers carrying a RFID tag (111) which is detected by an RFID reader (110) at a retail outlet. Any offers for the particular consumers detected are forwarded to the user's mobile telephone (112) as a SMS message so the user is alerted to the offers applicable to that consumer.

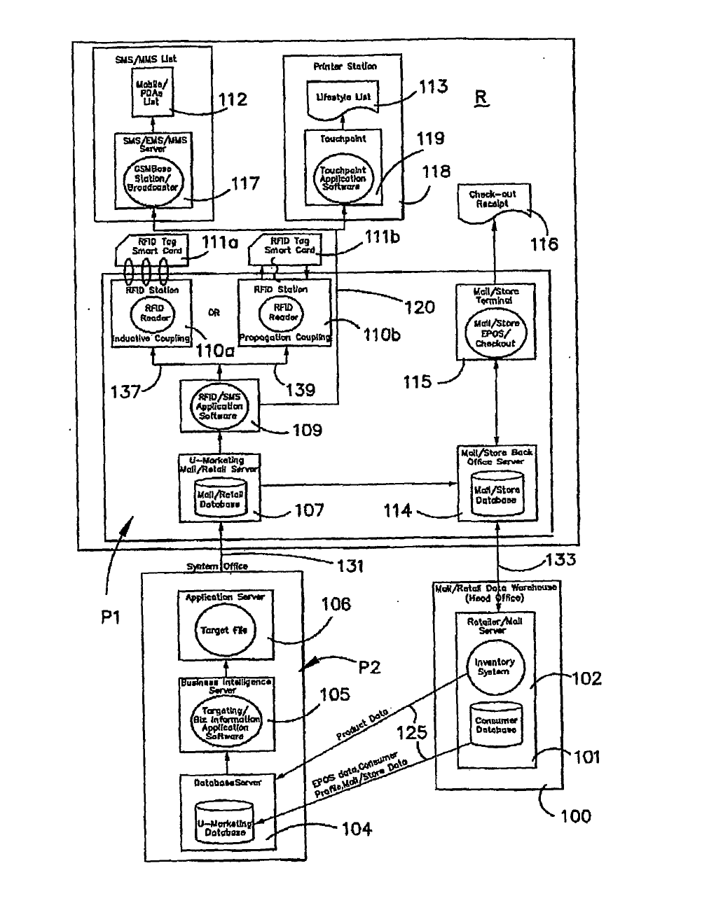

### FIELD OF THE INVENTION

This invention relates to a spontaneous delivery marketing system and method for providing offers to consumers.

### BACKGROUND OF THE INVENTION

It is common to advertise products to potential customers by making offers to customers for either trial of a particular product on a free sample basis, or providing products at a discount, or providing particular advantages such as additional products or the like to customers.

Typically, the manner in which customers are targeted is somewhat ad hoc and may simply comprise handouts or coupons which are obtained from checkouts. To improve customer targeting, systems have been provided where kiosks are installed at various points in a retail environment, such as a shopping mall, supermarket or hypermarket. These kiosks are fixed in position and require a consumer to interact with the kiosk in order to obtain a coupon or list which details offers available to the consumer which the consumer can redeem at the retail outlet.

Because the kiosks are fixed in position, consumers often bypass them, or if there is a queue, consumers will simply find the interaction process slow and inconvenient. This therefore results in relatively low usage rates.

Attempts have been made to manage traffic flow (foot traffic) so people pass by the kiosks to increase the likelihood that they will be used. However, such kiosks are still often bypasses, particularly if consumers are in a hurry.

Furthermore, kiosks are expensive and because the coverage is limited to physical interaction at the kiosk, the ability to reach out to consumers is low. Therefore to increase consumer availability, they often occupy the most expensive real estate in high traffic areas of a retail outlet.

### SUMMARY OF THE INVENTION

The object of the invention is to provide a method and system which improves the ability to provide offers to consumers.

The invention provides a spontaneous delivery marketing system for providing offers to consumers, comprising:
A detection device for detecting consumers, in proximity to a location where merchandise is available to the consumers, without requiring interaction by the consumers;
an output device for supplying a message to a detected consumer, providing offers available at the location to the consumer; and
wherein the detected consumers it therefore able to receive offers without physical interaction on his or her part, and to avail himself or herself of the offers contained in the message at the location.

Thus, rather than providing physical infrastructure, such as a kiosk which requires a consumer to physically react to obtain a message containing offers, the consumers is automatically detected without any interaction needed by the consumer and the message is therefore supplied to the consumer. Thus, consumers are much more likely to receive messages containing offers and to avail themselves of those offers, because they do not physically need to interact with a kiosk or other device to make their presence known and obtain the message. Because consumers are automatically identified, more consumers can be provided with messages, thereby increasing the effectiveness of providing offers, and therefore advertising products by specific messages to consumers.

In one embodiment the said location is a retail outlet, a mall, food court or event area.

In one embodiment the detection device comprises an RFID (radio frequency identification device) reader for reading an RFID tag carried by the consumer to identify a particular consumer.

Thus, the RFID tag can provide a unique code which provides a unique identification of a consumer so that individual consumers can be identified and distinguished from one another.

Preferably the RFID tag is contained in a card carried by the consumer.

In one embodiment the output device comprises a transmitter for wireless transmission of the message to the individual consumer's mobile telephone or PDA.

Preferably the message is an SMS, EMS or MMS message.

In another embodiment the output device is a printer for printing a document containing the offer. The document may comprise a shopping list, coupon or the like.

Preferably the system comprises a processor for receiving a target file of offers for individual consumers from a central station, the target offers being based on data held at the central station relating to personal information associated with individual consumers. Preferably the first processor comprises a first server for receiving the file, a second server associated with the location being connected to the first server, and an EPOS terminal connected with the second server so that offers contained in the list for a particular consumer are transmitted from the first server to the second server and then to the EPOS terminal so that when a consumer identifies himself or herself at the EPOS terminal, purchases made by the consumer are provided in accordance with the offers contained in the message to the consumer.

The consumer may identify himself or herself by displaying the message to a person at the checkout terminal, or by swiping a card which contains the user's identifying data at the EPOS terminal.

Preferably the second server is also coupled to a retail server for obtaining data relating to the purchases made by particular customers.

Preferably a second processor is located at the central location, the second processor comprising a head office database connected to the retail server for receiving data from the retail server relating to purchases made by particular customers, the head office database holding information relating to the consumers so that offers applicable to individual consumers can be made based on the data held in the database and particular products which marketers wish to promote by way of offers to consumers so that the offers to consumers are matched with characteristics of the consumers, so that consumers are provided with messages containing offers applicable to that consumer and tailored specifically for that consumer.

The retailer server may also include an inventory system for maintaining inventory data relating to products available at the location and for providing that data to the said database.

Preferably the retail server communicates with the second server for providing inventory data from the inventory system relating to products available for sale for use by the EPOS checkout during the purchase of products at the location.

Preferably the second processor further comprises an application server for producing the target file and transmitting the target file to the first server, the first server including a first server database for maintaining a database of specific offers targeted to specific consumers.

The invention provides a method of spontaneous delivery of marketing offers to consumers, comprising:
detecting consumers in proximity to a location where merchandise is available to the consumers, without requiring interaction by the consumers;
outputting a message to a detected consumer, providing offers available at the location to the consumer; and
wherein the detected consumers it therefore able to receive offers without physical interaction on his or her part, and to avail himself or herself of the offers contained in the message at the location.

In one embodiment the said location is a retail outlet, a mall, food court or event area.

In one embodiment detecting consumers comprises detecting an RFID tag carried by the consumer with an RFID reader to identify a particular consumer.

Thus, the RFID tag can provide a unique code which provides a unique identification of a consumer so that individual consumers can be identified and distinguished from one another.

In one embodiment outputting the message comprises wireless transmission of the message to the individual consumer's mobile telephone or Personal Digital Assistant (PDA) or like communication device.

Preferably the message is an SMS, EMS or MMS message.

In another embodiment outputting the message comprises printing a document containing the offer. The document may comprise a shopping list, coupon or the like.

Preferably the method further comprises receiving a target file of offers for individual consumers from a central station, the target offers being based on data held at the central station relating to personal information associated with individual consumers.

Preferably the method comprises receiving the file at a first server, transferring the file to a second server associated with the location, and to an EPOS terminal so that offers contained in the file for a particular consumer are transmitted from the first server to the second server and then to the EPOS terminal so that offers contained in the list for a particular consumer are transmitted from the office server to the store server and then to the EPOS terminal so that when a consumer identifies himself or herself at the EPOS terminal, purchases made by the consumer are provided in accordance with the offers contained in the message to the consumer.

The consumer may identify himself or herself by displaying the message to a person at the checkout terminal, or by swiping a card which contains the user's identifying data at the EPOS terminal.

Preferably the method further comprises compiling a database of information relating to the consumers sO that offers applicable to individual consumers can be made based on the data held in the database and particular products which marketers wish to promote by way of offers to consumers so that the offers to consumers are matched with characteristics of the consumers, so that consumers are provided with messages containing offers applicable to that consumer and tailored specifically for that consumer.

### BRIEF DESCRIPTION OF THE DRAWING

A preferred embodiment of the invention will be described, by way of example, with reference to the accompanying drawing.

### DETAILED DESCRIPTION OF THE PREFERRED EMBODIMENT

The system embodying the invention comprises a processor P1 which is located at a retail outlet. The retail outlet may be a mall, supermarket, hypermarket, or any other location where goods or services are available for sale.

Typically a processor P1 is located at each retail outlet R operating the system.

Typically a number of different retail locations R will offer the system and each of the retail locations R will communicate with a central station which has a second processor P2. Thus, a single second processor P2 will communicate with separate processors P1 at each retail outlet R operating the system. For ease of illustration, only one retail outlet R is shown in the accompanying drawing, and therefore only one processor P1 is shown. Each retail outlet R or all retail outlets R in a particular chain of retail outlets is provided with a retailer server 100. Thus, if for instance, ten retail outlets of a particular chain are operating the system, those ten retail outlets will have a single retail server 100. Another chain or another single retail outlet operating the system will have its own retail server 100.

The retail server 100 has a consumer database 101 and also holds the inventory system 102 of the chain of retail outlets R or the single retail outlet R. The consumer database is built up by purchase histories of participating consumers who use the system, and/or by consumers filling out application forms and providing data relating to the likes and dislikes of the consumer, shopping habits, demographics, personal characteristics, etc. Each consumer using the system is provided with an identifying device such as a smart card 111. The smart card 111 may contain a magnetic stripe which includes a unique identifying code which identifies the consumer. The smart card 111 also includes an RFID tag which outputs a radio frequency signal over a relatively short range also containing data which identifies the consumer.

The RFID tag contained in the smart card 111 may be a passive tag 111a which simply outputs a radio frequency signal, or a semi-passive or active RFID tag 111b that allows data to be stored in the tag, such as updating purchase history of a consumer or shopping information, loyalty points associated with loyalty programs and the like.

Each retail server 100 communicates with processor P2 by a communication network 125 such as a local area network, wide area network, internet connection or any other suitable communication link. The data contained in the consumer database 101 and the inventory contained in the system 102 of each server 100 is provided to a central authority marketing database 104 which is operated and managed by the organisation providing the entire system. The database 104 therefore collects all of the information from the specific customer databases 101 associated with each of the retail outlets R, and also the inventory data relating to all of the outlets R. Thus, the database 104 is a database of consumers in which the particular characteristics of the consumers and a code identifying the consumers is stored. Thus, each consumer has information relating to the purchase history of the consumer, the type of products of interest to the consumer, demographic information relating to the consumer and other relevant information which will provide an indication of the likelihood of the consumer being interested in particular types of products.

The processor P2 also has a business server 105 and is programmed with application software which receives information relating to particular offers marketers may wish to make to consumers to induce consumers to try their products or purchase their products in preference to other competing products. For example, marketers may offer a discount for purchase of products, two for the price of one offers for products, or other inducements to consumers to buy their products. The application software and server 105 therefore interacts with the data in the database 104 so that, for a particular offer, consumers who are likely to be attracted to the offer are extracted and an offer or list of offers is associated with each of the consumers who may be interested in the offers. That information is supplied to application server 106 which generates a target file of all of the consumers and offers which are to be made, and transmits the target file to a first retailer server 107. The first server 107 is typically provided by the authority which is operating the system and includes a database for storing the particular offers tailored for specific customers which are provided in the list from the application server 106. The first server 107 preferably comprises part of the processor P1, and therefore a server 107 is associated with each of the retail outlets R. However, in some embodiments, a single outlet server 107 may manage a number of retail outlets R or all outlets R operating the system. The target file is transmitted from the server 106 to the server 107 via a communication link 131 which may be the same type of link as the link 125 previously described.

The server 107 therefore compiles various offers associated with particular consumers and holds that information in its database.

Each retail outlet R will be provided with one or more RFID reader stations 110a or 110b. The readers 110a and 110b can be set up at obscure locations throughout the retail outlet R so that they do not occupy prime space and generally are unobserved by consumers going about their shopping experience.

When a smart card 111a or 111b carried by a consumer passes through the electromagnetic zone of the reader 110a or 110b, it detects the reader's activation signal and the reader 110a or 110b is able to decode the RFID tag data. Thus, the presence of the consumer in the retail outlet R is detected without the consumer having to physically interact with any device or the like in the shopping system. Thus, the consumer is simply detected when the consumer passes one of the reader stations 110a or 110b.

When the unique code associated with a particular user is identified, the reader 110a and 110b outputs a signal to RFID application software 109 in the processor P1 so the application software causes the list of offers associated with that particular consumer, if there is one for that articular consumer, to be extracted from the database within the server 107. The processor P1 via the application software 109 therefore outputs data relating to the offers which are to be made on line 120 and 121 to GSM base station broadcaster 117 so that the station 117 is caused to transmit an SMS message to the mobile telephone associated with the consumer so the message is received by the user's mobile telephone 112. Alternatively, the message may be transmitted to the user's PDA.

In the case of the reader 110a simply reading a passive RFID tag in smart card 111a, the link between the processor P1 which runs the software 109 and the reader 110a may simply be an inductive coupling illustrated by line 137. Thus, the reader 110a need only provide some signal to the processor software 109 to identify the particular customer. In the case of an active RFID tag in smart card 111b for example, the reader station 110b has a propagation coupling so that information can be transmitted back and forth from the application software via line 139 for updating information in the smart card 111b, such as shopping history, reward points, etc.

The data relating to the user retained in the database 104 includes the telephone number of the user's mobile telephone so that all the information is provided through to the processor P1 and then to the station 117 for generating the SMS message with the particular offers for that consumer and then transmitting the messages by way of an SMS message or the like to the user's mobile telephone 112.

Thus, the user receives the SMS message and is able to simply look at the offers which are being made available to that particular customer and the customer may choose to purchase, in accordance with those offers or simply to ignore the offers.

If the consumer does not have a mobile telephone or PDA, the user can visit a specific location in the retail outlet R such as a touch point location 119 which includes a card reader for reading the magnetic stripe on the user's smart card 111 and the offers will be printed out as a list 113 to the user. Whilst this does involve some interaction by the user, the interaction is not needed in order to detect the customer. Interaction may be needed to generate the list so the list is available for the user to collect, should the user simply choose to visit the touch point location 119. The interaction at the touch point location 119 may be by swiping the smart card. However, the touch point location 119 may be provided with a reader which simply reads the RFID tag in the touch card and prints the list for collection as the user approaches the touch point location 119.

The outlet server 107 is also connected to a second retailer back office server 114 associated with the retail outlet R. Once again, in the preferred embodiment, the server 114 is part of the processor P1 and each retail outlet R has a server 114. However, in other embodiments, a single server 114 may manage a number of retail outlets R. The server 114 connects to the EPOS terminal 115 of the store so that the data relating to the particular offers made available to consumers is also transmitted via the server 114 to the EPOS terminal 115.

When the consumer presents at the retail server 115 to pay for goods which the consumer has chosen to buy, the consumer identifies himself or herself so that any offers which have been taken up by the consumer are provided in accordance with those offers. This can be done by the consumer showing the message on the user's mobile telephone or by the user simply swiping his or her smart card 111 through a card reader at the terminal 115.

Data relating to the price of products is also fed to the EPOS terminal 115 from the inventory system 102 via the server 114 for normal pricing of products, offers, discounts, product descriptions/product specifications, etc. purchased by the consumer. The retail server 100 which contains the inventory system 102 and the consumer database 101 is connected to the second server 114 by a communication link 133 which, again, may be the same type of link as the links 125 and 131. The server 100 is also able to obtain data back from the EPOS terminal 115 via the database 114 and communication link 133 which relates to purchases made by various customers. This allows the information in the database 101, and therefore in the database 104, to be updated. Thus, this information can be continually updated over time when consumers shop at the retail outlet R and pay for goods at the checkout terminal 115 so that the characteristics of the consumer are confirmed or are modified if the consumer changes his or her buying habits.

The server 100 may also communicate with the second server 114 and therefore the EPOS terminal 115 to provide offers and other inducements to customers which are generated only by the retail outlet R or chain of retail outlets R, rather than by the central station at which the processor P2 is located. Thus, this enables individual retailers to make their own discount offers, as well as those which are made by various advertisers or marketers via the central station.

The EPOS terminal 115 will also provide a checkout receipt 116 which may not only include details of the purchases which have been made, but may also contain additional offers which are available to the consumer next time the consumer visits the retail outlet R.

In other embodiments the message containing particular offers may also be provided in other ways. For example, when a consumer is identified by the reader 110a or 110b, the reader 110a and 110b may activate with RFID readers a TV screen which runs an advertisement or several advertisements relating to products of interest to that particular consumer.

The offers provided in the message may be direct offers for purchase of products or offers relating to where products may be obtained or demonstrations or the like associated with particular products, all designed to induce or entice people to particular products which are expected to be of interest to that consumer.

In still further embodiments, the smart card 111 may be linked to financial cards or financial institutions so that payments can be electronically made by use of the card 111.

Although the preferred embodiment shows processor P1 forming or controlling the first server 107, the readers 110, the second server 114 and the checkout 115, the processor P1 may in fact be a number of individual processors, each managing or controlling those servers and terminal.

Similarly, the processor P2 may be formed by a number of individual processors for controlling and managing the database 104, the server and application software 105, and the application server 106.

In the claims which follow and in the preceding description of the invention, except where the context requires otherwise due to express language or necessary implication, the word “comprise”, or variations such as “comprises” or “comprising”, is used in an inclusive sense, ie. to specify the presence of the stated features but not to preclude the presence or addition of further features in various embodiments of the invention.

1. A spontaneous delivery marketing system for providing offers to consumers, comprising:
a detection device for detecting consumers, in proximity to a location where merchandise is available to the consumers, without requiring interaction by the consumers;
a processor for generating offers applicable to a detected consumer based on data held in a database relating to characteristics of the detected consumer, so that from a number of offers available, those which relate to the detected consumer based on the characteristics of the consumer are generated, to thereby produce different offers specific to individual consumers;
an output device for supplying a message to a detected consumer, providing the offers available at the location to the consumer; and
wherein the detected consumer is therefore able to receive offers without physical interaction on his or her part, and to avail himself or herself of the offers contained in the message at the location.

2. The system of claim 1 wherein the said location is a retail outlet, a mall, food court or event area.

3. The system of claim 1 wherein the detection device comprises an RFID (radio frequency identification device) reader for reading an RFID tag carried by the consumer to identify a particular consumer.

4. The system of claim 3 wherein the RFID tag can provide a unique code which provides a unique identification of a consumer so that individual consumers can be identified and distinguished from one another.

5. The system of claim 4 wherein the RFID tag is contained in a card carried by the consumer.

6. The system of claim 1 wherein the output device comprises a transmitter for wireless transmission of the message to the individual consumer's mobile telephone or PDA.

7. The system of claim 6 wherein the message is an SMS, EMS or MMS message.

8. The system of claim 1 wherein the output device is a printer for printing a document containing the offer.

9. The system of claim 1 wherein the processor receives a target file of offers for individual consumers from a central station, the target offers being based on data held at the central station relating to personal information associated with individual consumers.

10. The system of claim 9 wherein the first processor comprises a first server for receiving the file, a second server associated with the location being connected to the first server, and an EPOS terminal connected with the second server so that offers contained in the list for a particular consumer are transmitted from the first server to the second server and then to the EPOS terminal so that when a consumer identifies himself or herself at the EPOS terminal, purchases made by the consumer are provided in accordance with the offers contained in the message to the consumer.

11. The system of claim 10 wherein the consumer identifies himself or herself by displaying the message to a person at the EPOS terminal, or by swiping a card which contains the user's identifying data at the EPOS terminal.

12. The system of claim 10 wherein the second server is also coupled to a retail server for obtaining data relating to the purchases made by particular customers.

13. The system of claim 10 wherein a second processor is located at the central location, the second processor comprising a head office database connected to the retail server for receiving data from the retail server relating to purchases made by particular customers, the head office database holding information relating to the consumers so that offers applicable to individual consumers can be made based on the data held in the database and particular products which marketers wish to promote by way of offers to consumers so that the offers to consumers are matched with characteristics of the consumers, so that consumers are provided with messages containing offers applicable to that consumer and tailored specifically for that consumer.

14. The system of claim 13 wherein the retailer server may also include an inventory system for maintaining inventory data relating to products available at the location and for providing that data to the said database.

15. The system of claim 14 wherein the retail server communicates with the second server for providing inventory data from the inventory system relating to products available for sale for use by the EPOS checkout during the purchase of products at the location.

16. The system of claim 10 wherein the second processor further comprises an application server for producing the target file and transmitting the target file to the first server, the first server including a first server database for maintaining a database of specific offers targeted to specific consumers.

17. A method of spontaneous delivery of marketing offers to consumers, comprising:
detecting consumers in proximity to a location where merchandise is available to the consumers, without requiring interaction by the consumers;
generating offers applicable to a detected consumer based on data held in a database relating to characteristics of the detected consumer, so that from a number of offers available, those which relate to the detected consumer based on the characteristics of the consumer are generated, to thereby produce different offers specific to individual consumers;
outputting a message to a detected consumer, providing the offers available at the location to the consumer; and
wherein the detected consumer is therefore able to receive offers without physical interaction on his or her part, and to avail himself or herself of the offers contained in the message at the location.

18. The method of claim 17 wherein the said location is a retail outlet, a mall, food court or event area.

19. The method of claim 17 wherein detecting consumers comprises detecting an RFID tag carried by the consumer with an RFID reader to identify a particular consumer.

20. The method of claim 17 wherein outputting the message comprises wireless transmission of the message to the individual consumer's mobile telephone or PDA.

21. The method of claim 20 wherein the message is an SMS, EMS or MMS message.

22. The method of claim 17 wherein outputting the message comprises printing a document containing the offer.

23. The method of claim 17 wherein the method further comprises receiving a target file of the offers for individual consumers from a central station, the target offers being based on data held at the central station relating to personal information associated with individual consumers.

24. The method of claim 23 wherein the method comprises receiving the file at a first server, transferring the file to a second server associated with the location, and to an EPOS terminal so that offers contained in the file for a particular consumer are transmitted from the first server to the second server and then to the EPOS terminal so that offers contained in the list for a particular consumer are transmitted from the office server to the store server and then to the EPOS terminal so that when a consumer identifies himself or herself at the EPOS terminal, purchases made by the consumer are provided in accordance with the offers contained in the message to the consumer.

25. The method of claim 17 wherein the consumer may identify himself or herself by displaying the message to a person at the checkout terminal, or by swiping a card which contains the user's identifying data at the EPOS terminal.

26. The method of claim 25 wherein the method further comprises compiling a database of information relating to the consumers so that offers applicable to individual consumers can be made based on the data held in the database and particular products which marketers wish to promote by way of offers to consumers so that the offers to consumers are matched with characteristics of the consumers, so that consumers are provided with messages containing offers applicable to that consumer and tailored specifically for that consumer.

27. A spontaneous delivery marketing system for providing offers to consumers, comprising:
a detection device for detecting consumers, in proximity to a location where merchandise is available to the consumers, without requiring interaction by the consumers;
a first processor for receiving a file of offers, the first processor being associated with the location;
a second processor at a central station for compiling the offers for transmission to the first processor;
an output device for providing a message to a consumer containing offers from the file of offers; and
an EPOS terminal at the location at which payment for goods or services can be made, and for receiving the file of offers relating to a consumer from the second processor so that if the consumer purchases offers included in the message, the consumer pays for those offers in accordance with the offers as transmitted to the EPOS terminal.

28. The system of claim 27 wherein the consumer identifies himself or herself by displaying the message to a person at the EPOS terminal, or by swiping a card which contains a user's identifying data at the EPOS terminal.

29. The system of claim 27 wherein the second processor compiles a list of specific offers for consumers based on a database contained at the central station, the offers being based on data held in the database which relates to personal information associated with the individual consumers so that specific offers are generated for specific individual consumers.

30. The system of claim 27 wherein the detection device comprises RFID reader for reading an RFID tag carried by the consumer to identify a particular consumer.

31. The system of claim 29 wherein the second processor comprises a head office database connected to a retail server for receiving data from the retail server relating to purchases made by particular customers, the head office database holding information relating to the consumers so that offers applicable to individual consumers can be made based on the data held in the database and particular products which marketers wish to promote by way of offers to consumers so that the offers to consumers are matched with characteristics of the consumers, so that consumers are provided with messages containing offers applicable to that consumer and tailored specifically for that consumer.

32. A method of spontaneous delivery of marketing offers, comprising:
detecting consumers in proximity to a location where merchandise is available to the consumers, without requiring interaction by the consumers;
compiling offers at a central station for transmission to the location;
processing a file of the offers at the location;
providing a message containing offers from the file of offers to a consumer; and
receiving the file of offers relating to a consumer by an EPOS terminal at the location so that if the consumer purchases offers included in the message, the consumer pays for those offers in accordance with the offers as transmitted to the EPOS terminal.

33. The method of claim 32 wherein the consumer identifies himself or herself by displaying the message to a person at the EPOS terminal, or by swiping a card which contains a user's identifying data at the EPOS terminal.

34. The method of claim 32 wherein the list of offers for a consumer is a specific list for an individual consumer based on a database contained at the central station, the offers being based on data held in the database which relates to personal information associated with the individual consumers so that specific offers are generated for specific individual consumers.

35. The method of claim 32 wherein the detection step comprises detecting an RFID tag carried by the consumer to identify a particular consumer.
